(19) United States
(12) Patent Application Publication
(10) Pub. No.: US 2015/0008302 A1
(43) Pub. Date: Jan. 8, 2015

(54) FLEXIBLE SUPPORT APPARATUS

(71) Applicant: Eagle Fan, Hsinchu (TW)

(72) Inventor: Eagle Fan, Hsinchu (TW)

(21) Appl. No.: 13/934,392

(22) Filed: Jul. 3, 2013

(51) Int. Cl. F16M 13/00

(52) U.S. Cl. CPC F16M 13/00
USPC 248/558

(57) ABSTRACT

A flexible support apparatus is provided, including a flexible plate and a wrapping layer, wherein the flexible plate is made of flexible tin plate, and the wrapping layer wraps around the circumference of the flexible plate. The wrapping layer is made of a soft material with high friction coefficient. The flexible plate having a thickness of 3-7 mm and the wrapping layer having a thickness of 1-4 mm. As such, the user can bend the flexible plate into various shape for placing an electronic device to be held standing at a specific angle.

### FIELD OF THE INVENTION

The present invention generally relates to a support apparatus, and more specifically to a support apparatus ale to bend to various shape to accommodate the placement of an electronic device.

### BACKGROUND OF THE INVENTION

The majority of support apparatuses have a rigid structure with a fixed shape. While some support apparatuses are composed of a plurality of elements assembled together to form a fixed structure when expanded for placing or holding a portable electronic device. In this type of support apparatuses, the user can only change the shape of the support apparatus with limited variations.

With more portable electronic devices available in the market, the support apparatus of fixed structure can be only used to support certain types of devices. Once the electronic devices phase out, a different support apparatus of different structure must be designed to match the newer electronic devices. It is imperative to devise a support apparatus that can accommodate more different types of electronic devices more flexibly.

### SUMMARY OF THE INVENTION

The primary object of the present invention is to provide flexible support apparatus able to change shape. The support apparatus is made of flexible material so that the user can bend the support apparatus into various shapes to hold or place portable electronic device. To change the placement angle, the support apparatus can be bent further or less. As such, the flexible support apparatus can accommodate more different types of electronic devices.

Another object of the present invention is to provide a flexible support apparatus that is low in manufacturing cost and easy for storage. The support apparatus can be bent into three-dimensional structure when in use for supporting an electronic device. For storage, the flexible support apparatus can be completely flattened to save storage space. As the structure is simple, the manufacturing cost is low for market competition.

To achieve the above objects, the present invention provides a flexible support apparatus, including a flexible plate and a wrapping layer. The flexible plate is made of flexible material, such as, tin plate. The wrapping layer wraps around the surface of the circumference. The wrapping layer is made of soft material with a high friction coefficient. The thickness of the flexible plate is preferably 3-7 mm, and the thickness of the wrapping layer is preferably 1-4 mm. As such, the user can bend the flexible plate into various shapes for placing and holding an electronic device.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view according to the present invention;

FIG. 2 shows a cross-sectional view along line AA of FIG. 1;

FIG. 3 shows a schematic view of the flexible plate of the present invention bent to form a three-dimensional shape;

FIG. 4 shows a schematic view of the present invention with a tablet PC placed on; and

FIG. 5 shows a schematic view of the present invention with a mobile phone placed on.

### DETAILED DESCRIPTION OF THE PREFERRED EMBODIMENTS

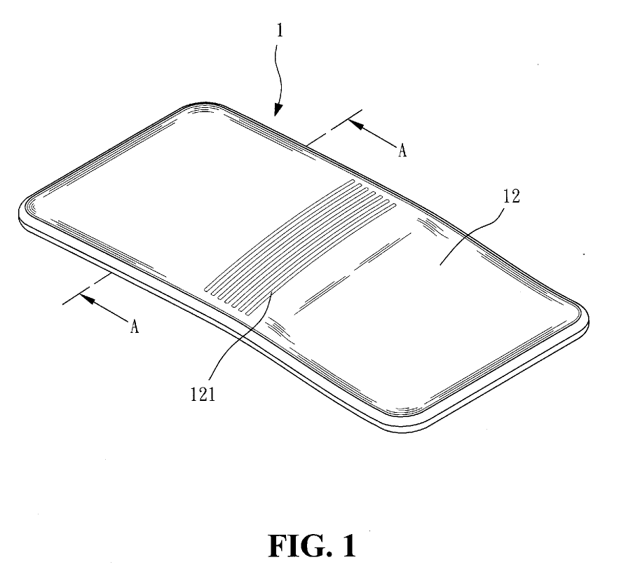

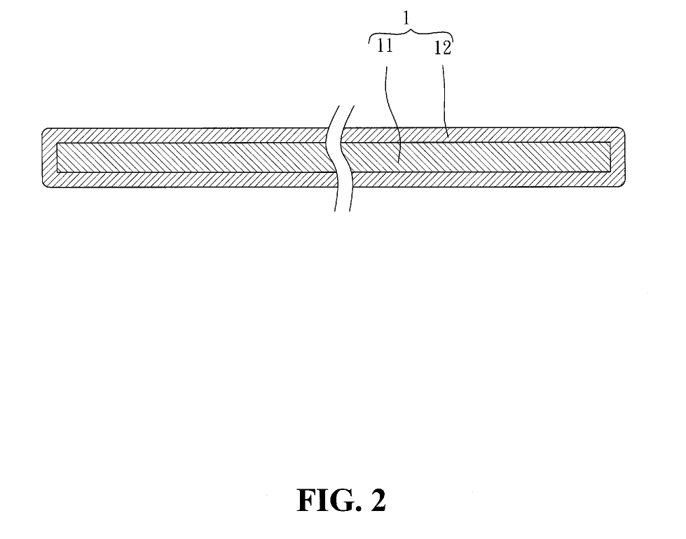

FIG. 1 and FIG. 2 show a schematic view and a cross-sectional of the present invention respectively. A flexible support apparatus 1 of the present invention includes a flexible plate 11 and a wrapping layer 12. The flexible plate 11 is made of a flexible material, such as, tin plate, wrapped by a wrapping layer 12 on the surface of the circumference. The wrapping layer 12 is made of a soft material with high friction coefficient. In a preferred embodiment of the present invention, the wrapping layer 12 is made of silicone. The thickness of the flexible plate 11 is preferably 3-7 mm, and in particular, 4-6 mm. The thickness of the wrapping layer 12 is preferably 1-4 mm, and in particular, 1.5-2.5 mm. The wrapping layer 12 made of silicone in the present embodiment is attached to the surface of the flexible plate 11. With suitable thicknesses of the flexible plate 11 and wrapping layer 12, the user can easily bend the present invention. When carrying a portable electronic device, the present invention will not deform. In addition, the flexible plate 11 and wrapping layer 12 are firmed attached so that they will not detach with repetitive bending and flattening.

Furthermore, for convenience, the present invention disposes a plurality of grooves 121 on the surface of wrapping layer 12 to allow the user to perform large angle bending. The wrapping layer 12 made of soft silicone provides a large friction to the electronic device placed upon so that the electronic device is fixed and stationary. In addition, the support apparatus 1 will not slide on the surface it is placed on, such as, a desk top.

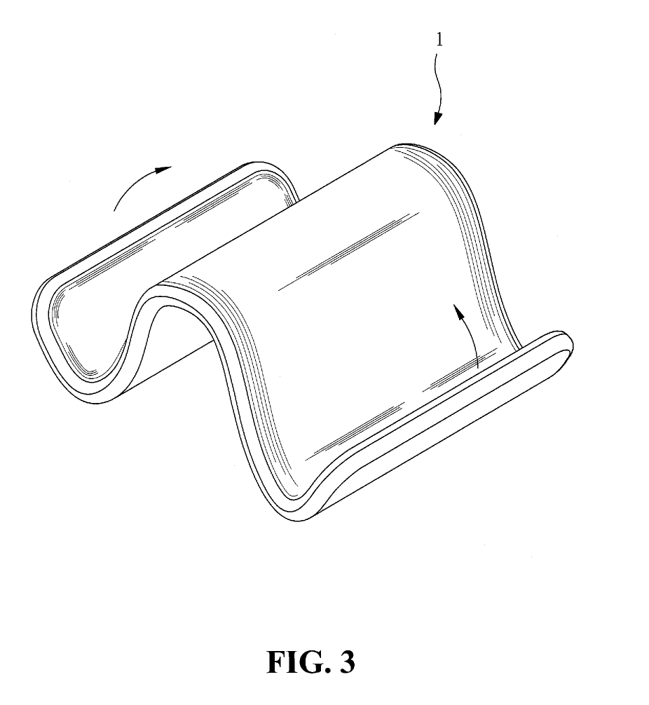

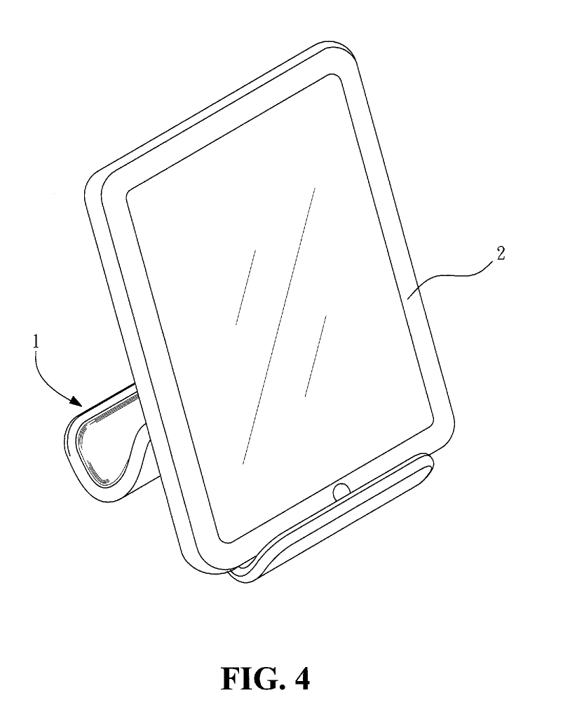

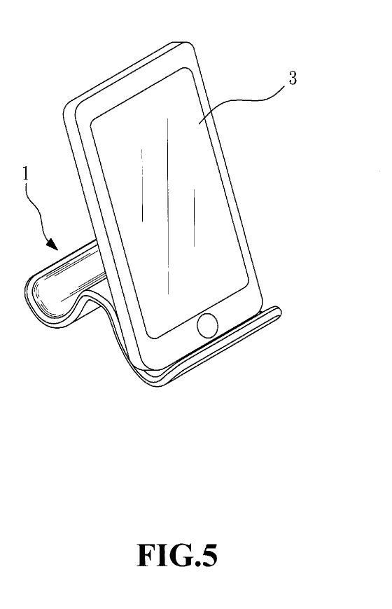

FIG. 3 shows a schematic view of the present invention in actual application. The flexible plate 11 is bent to form a three-dimensional shape. In the present embodiment, a wavy shape or a horizontal S-shape is formed. As shown in FIG. 4 and FIG. 5, the portable electronic device can be a tablet PC 2 or a mobile phone 3. The actual size of the support apparatus 1 can be made in accordance with the electronic device. When in use, the bottom edge of the portable electronic device, such as tablet PC 2 or mobile phone 3 is stuck inside the groove and the back of portable electronic device leans against on a peak of the support apparatus 1 so that the portable electronic device stands in a tilt position. To change the standing angle, the user only needs to adjust the bending of the support apparatus 1. As such, the user can easily and conveniently bend the support apparatus of the present invention.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A flexible support apparatus, comprising:
a flexible plate; and
a wrapping layer;
wherein the flexible plate being made of flexible tin plate, and the wrapping layer wrapping around the circumference of the flexible plate, the wrapping layer being made of a soft material with high friction coefficient, the flexible plate having a thickness of 3-7 mm and the wrapping layer having a thickness of 1-4 mm.

2. The flexible support apparatus as claimed in claim 1, wherein the wrapping layer is made of soft silicone.

3. The flexible support apparatus as claimed in claim 1, wherein the thickness of flexible plate is preferably 4-6 mm.

4. The flexible support apparatus as claimed in claim 1, wherein the thickness of the wrapping layer is preferably 1.5-2.5 mm.
